(19) United States
(12) Patent Application Publication
(10) Pub. No.: US 2009/0049382 A1
(43) Pub. Date: Feb. 19, 2009

(54) Interactive hybrid printed material interface system and method

(76) Inventors: Jason E. Barkeloo, Cincinnati, OH (US); David A. Krauth, Manchester, NH (US)

Correspondence Address: TAFT, STETTINIUS & HOLLISTER LLP, SUITE 1800, 425 WALNUT STREET, CINCINNATI, OH, 45202-3957, US

(21) Appl. No.: 12/228,657

(22) Filed: Aug. 14, 2008

Related U.S. Application Data
(60) Provisional application No. 60/964,636, filed on Aug. 14, 2007.

(51) Int. Cl. G06F 3/048; G06F 21/00; G06Q 30/00; G06F 15/16

(52) U.S. Cl. 715/702; 726/26; 705/14; 715/748

(57) ABSTRACT

One aspect provides a method of outputting digital content from an interactive user device that includes the steps of: (a) providing a printed publication including a plurality of printed objects associated with digital content; (b) providing an interactive user device having circuitry adapted to generate and transmit a location signal; (c) providing a server device for storing the digital content; (d) providing an output device electronically coupled to the interactive user device; (e) actuating the circuitry corresponding to one of the plurality of printed objects; (f) transmitting a first signal from the interactive user device to the server device, where the first signal includes a request to access the digital content; (g) receiving a second signal from the server device, where the second signal includes the digital content, a location thereof, and/or instructions for outputting the digital content; and (h) outputting the digital content on the output device.

### CROSS-REFERENCE TO RELATED APPLICATIONS

This application claims the benefit of U.S. Provisional Application Ser. No. 60/964,636, entitled “INTERACTIVE HYBRID PRINTED MATERIAL INTERFACE SYSTEM AND METHOD,” filed on Aug. 14, 2007, the disclosure of which is incorporated herein by reference.

### FIELD OF THE INVENTION

The present invention relates to a system and method of digital content delivery. Specifically, the present invention involves retrieval of digital content, launching of applications and/or protocols related to the digital content, and generating revenue associated with digital content delivery.

### BACKGROUND OF THE INVENTION

Innovations have begun to transform conventional books and other printed publications into multi-media interactive devices. Printed publications have been fitted to connect electronically with computers and other media storage devices to retrieve and display digital content. In some instances, the printed publications have an integrated remote control device capable of interacting wirelessly with the media storage devices and in other instances, the printed publications are tethered to the media storage devices with a local connection such as a USB connection or cable connection. This technology enables, for example, a reader to press the pictures and words on the regular printed ink and paper page and retrieve digital content from a computer or other media storage device.

### SUMMARY OF THE INVENTION

Embodiments of the present invention provide a content delivery system that allows for retrieval of digital content from a server, the launching of applications from an interactive user device, and revenue generation based on advertisements.

It is a first aspect of the invention to provide a method of outputting digital content from an interactive user device that includes the steps of: (a) providing a printed publication including a plurality of printed objects associated with digital content, where the printed objects have location coordinates relative to the printed publication; (b) providing an interactive user device having circuitry adapted to generate and transmit a location signal associated with the location coordinates; (c) providing a server device for storing the digital content; (d) providing an output device for outputting the digital content, where the output device is electronically coupled to the interactive user device; (e) actuating, by a user, the circuitry corresponding to one of the plurality of printed objects; (f) upon actuation of the circuitry, transmitting a first signal from the interactive user device to the server device, where the first signal includes a request to access the digital content corresponding to the actuated printed object; (g) receiving a second signal from the server device, where the second signal includes the digital content, a location of the digital content, and/or instructions for outputting the digital content; and (h) outputting the digital content on the output device.

In one embodiment of this aspect, the digital content is a protocol, an interface and/or an application. In another embodiment, the application is a browser application, an email application, a messaging application, an voice-over-Internet-Protocol application, an image application, a video application and/or an audio application. In another embodiment, the digital content is an Internet resource, a website, a networked resource, audio content, video content, and/or image content. In yet another embodiment, the output device is a computing device, a personal computer, a personal digital assistant, a digital video disc (DVD) player, a television, a cellular device, an audio player device and/or a video player device.

It is a second aspect of the invention to provide a digital content transmission system that includes a printed publication including a plurality of printed objects associated with digital content, where the printed objects have location coordinates relative to the printed publication, an interactive user device having circuitry adapted to generate and transmit a location signal associated with the location coordinates, where the circuitry corresponds to one of the plurality of printed objects, a server device for storing the digital content, and an output device for outputting the digital content, where the output device being electronically coupled to the interactive user device. The interactive user device is adapted to transmit a first signal, where the first signal includes a request to access the digital content corresponding to the actuated printed object. Further, The server device is adapted to transmit a second signal, where the second signal includes the digital content, a location of the digital content, and/or instructions for outputting the digital content.

In one embodiment of this aspect, the digital content is a protocol, an interface and/or an application. In one embodiment, the application is a browser application, an email application, a messaging application, an voice-over-Internet-Protocol application, an image application, a video application and/or an audio application. In another embodiment, the digital content is an Internet resource, a website, a networked resource, audio content, video content, and/or image content. In yet another embodiment, the output device is a computing device, a personal computer, a personal digital assistant, a digital video disc (DVD) player, a television, a cellular device, an audio player device and/or a video player device.

It is a third aspect of the invention to provide a method of initiating software instructions from an interactive user device that includes the steps of: (a) providing a printed publication including a plurality of printed objects associated with digital content, where the printed objects have location coordinates relative to the printed publication; (b) providing an interactive user device having circuitry adapted to generate and transmit a location signal associated with the location coordinates; (c) providing a server device for storing the digital content; (d) providing an output device electronically coupled to the interactive user device; (e) actuating, by a user, the circuitry corresponding to one of the plurality of printed objects; (f) upon actuation of the circuitry, executing software instructions configured to activate an application, a protocol, and/or an interface; and (g) outputting results of the executing step to the output device.

In one embodiment of this aspect, the application is a browser application, an email application, a messaging application, an voice-over-Internet-Protocol application, an image application, a video application and/or an audio application. In one embodiment, the protocol includes a communication protocol and/or a file transfer protocol. In another embodiment, the protocol an Internet Protocol (IP), a Hypertext Transfer Protocol (HTTP), a File Transfer Protocol (FTP), a User Datagram Protocol (UDP), a Transmission Control Protocol (TCP), a Dynamic Host Configuration Protocol (DHCP), a Telnet Remote Protocol, a Secure Shell Remote Protocol (SSH), a Post Office Protocol 3 (POP3), a Simple Mail Transfer Protocol (SMTP), an Internet Message Access Protocol (IMAP) and/or an Internet Protocol Suite (TCP/IP).

It is a fourth aspect of the invention to provide a system for initiating software instructions that includes a printed publication including a plurality of printed objects associated with digital content, where the printed objects have location coordinates relative to the printed publication, an interactive user device having circuitry adapted to generate and transmit a location signal associated with the location coordinates, where the circuitry corresponds to one of the plurality of printed objects, a server device for storing the digital content, and an output device electronically coupled to the interactive user device. Actuation of the circuitry causes the interactive user device to execute software instructions configured to activate an application, a protocol, and/or an interface.

In one embodiment of this aspect, the application is a browser application, an email application, a messaging application, an voice-over-Internet-Protocol application, an image application, a video application and/or an audio application. In one embodiment, the protocol includes a communication protocol and/or a file transfer protocol. In another embodiment, the protocol an Internet Protocol (IP), a Hypertext Transfer Protocol (HTTP), a File Transfer Protocol (FTP), a User Datagram Protocol (UDP), a Transmission Control Protocol (TCP), a Dynamic Host Configuration Protocol (DHCP), a Telnet Remote Protocol, a Secure Shell Remote Protocol (SSH), a Post Office Protocol 3 (POP3), a Simple Mail Transfer Protocol (SMTP), an Internet Message Access Protocol (IMAP) and/or an Internet Protocol Suite (TCP/IP).

It is a fifth aspect of the invention to provide a method of generating an interactive printed publication that includes the steps of: (a) transmitting an electronic file to a server device, where the electronic file represents a page having graphical objects; (b) converting the graphical objects into touch user interface pages; (c) adding an image to one or more of the touch user interface pages; and (d) linking the image with digital content; (e) generating one or more interactive digital pages including the results from the linking step; and (f) printing onto a substrate the one or more interactive digital pages to create one or more interactive printed publications. The interactive printed publications are visually substantially similar to the interactive digital pages. The actuation of one of the images on the interactive printed publications causes the retrieval of the digital content.

In one embodiment, this aspect further includes the steps of: transmitting the plurality of touch user interface pages to a hosting service, and storing, by a hosting service, the plurality of touch user interface pages. In another embodiment, this aspect further includes the steps of: accessing, by a third party, one or more of the stored touch user interface pages, recording, by the hosting service, information related to at least one of the third party, the user, the touch user interface pages and the accessing of the touch user interface pages, and generating revenue by the hosting service based, at least in part, on the accessing step. In yet another embodiment, this aspect further includes the steps of: generating web pages related to the plurality of touch user interface pages, adding electronic advertisements to the web pages, and allowing third parties to access to the web pages.

In yet another embodiment, the image is an icon, an advertisement, a logo, a slogan, a trademark and/or a button. In another embodiment, the steps are performed by a user via a website service. In yet another embodiment, the user may print the touch user interface pages for use with an interactive user device.

It is a sixth aspect of the invention to provide a method of generating revenue through advertising that includes the steps of: (a) providing a printed publication including a plurality of printed objects associated with digital content, where the printed objects have printed advertisements and having location coordinates relative to the printed publication; (b) providing an interactive user device having circuitry adapted to generate and transmit a location signal associated with the location coordinates; (c) providing a server device for storing the digital content; (d) providing an output device electronically coupled to the interactive user device; (e) actuating, by a user, the circuitry corresponding to the printed advertisement; (f) upon actuation of the circuitry corresponding to the printed advertisement, executing software instructions configured to retrieve a web page related to the printed advertisement; and (g) generating revenue from an entity related to the printed advertisement and/or the web page related to the printed advertisement based, at least in part, on the retrieval of the web page related to the printed advertisement.

In one embodiment, this aspect further includes the steps of: completing an e-commerce transaction between the user and the web page; and generating revenue from an entity related to the printed advertisement and/or the web page related to the printed advertisement based, at least in part, on the e-commerce transaction.

From the foregoing disclosure and the following detailed description of various preferred embodiments it will be apparent to those skilled in the art that the present invention provides a significant advance in the art of interactive printed material interface systems and methods. Additional features and advantages of various preferred embodiments will be better understood in view of the detailed description provided below.

### BRIEF DESCRIPTION OF THE DRAWINGS

The present invention will be understood and appreciated more fully from the detailed description in conjunction with the following drawings in which:

FIG. 1 is a diagram of an exemplary embodiment of an interactive printed material launching various protocols, applications, interfaces, and digital content;

FIG. 2 is a diagram of an exemplary embodiment of an interactive printed material electronically coupled with various third-party appliances;

FIG. 3 is a flow chart of an exemplary embodiment of one aspect of the present invention.

### DETAILED DESCRIPTION

It will be apparent to those skilled in the art that many uses and variations are possible for the system and method disclosed herein. The following detailed discussion of various alternative and preferred embodiments will illustrate the general principles of the invention. Other embodiments will be apparent to those skilled in the art given the benefit of this disclosure.

In a first aspect of the present invention, the user is provided the capability to launch protocols, interfaces and other applications such as email by touching the interactive printed material (“IPM”) 10. The interactive printed material 10 of the present invention includes a printed circuit board connected to at least one membrane switch, which is overlaid by a printed publication. In an exemplary embodiment of the present invention, a constant current is being supplied to the membrane(s). The printed publication is associated with the switches of the underlying membrane. When the user touches text and/or graphics on the printed publication, a switch on the underlying membrane is activated, thereby outputting a particular voltage. This particular voltage indicates the content to be retrieved or the application to be launched. Examples of such IPMs 10 are described in U.S. Pat. Nos. 5,624,265, 5,757,304, 5,749,735, 5,763,112, 5,788,507, 5,839,905, 5,911,582, 5,957,695, 6,327,459 and 6,650,867, the disclosures of which are incorporated by reference.

In accordance with the first aspect, an interactive printed material 10 allows the user to launch protocols, interfaces and applications. The system uses the touch user interface of an interactive printed material 10 to, for example, conduct electronic commerce 12 transactions, display audio/video presentations 14, display videos 16, launch voice-over-Internet-Protocol (“VoIP”) applications 18, display animations 20, navigate to websites 22, access digital rights management applications 24, and launch instant messaging applications 26, for example. Instead of utilizing solely a graphical user interface on a computer, the touch user interface of the interactive printed material 10 may serve as an entrance point to launch protocols and applications.

In an exemplary embodiment of this aspect, an interactive printed material 10 is provided including a cover (a hard, plastic shell in one embodiment), printed circuit board, at least one membrane switch, a USB board, and a interactive printed publication booklet. The membrane switches of the interactive printed material 10 are responsive to applied pressure (typically, the touch of the user's finger), and output a voltage specific to the location of the applied pressure. This voltage is translated into a binary output and used to command a specific action by another protocol or application.

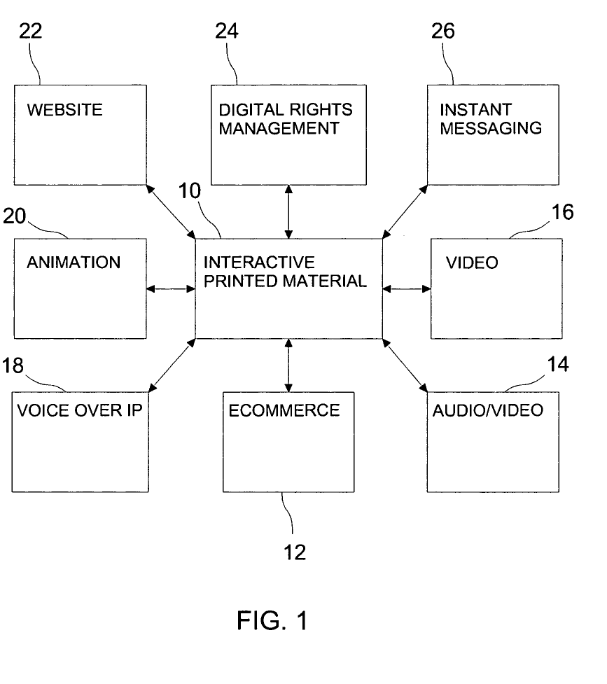

As seen in FIG. 1, an exemplary embodiment of this aspect may launch applications and protocols related to electronic commerce 12 transactions, audio/video presentations 14, videos 16, VoIP applications 18, animations 20, websites 22, digital rights management applications 24, and instant messaging applications 26. Other applications and protocols may be related to audio, voice, music, browsers, email applications. Any protocol may be launched in exemplary embodiments. Some examples include Internet Protocol (IP), Hypertext Transfer Protocol (HTTP), File Transfer Protocol (FTP), User Datagram Protocol (UDP), Transmission Control Protocol (TCP), Dynamic Host Configuration Protocol (DHCP), Telnet Remote Protocol, Secure Shell Remote Protocol (SSH), Post Office Protocol 3 (POP3), Simple Mail Transfer Protocol (SMTP), Internet Message Access Protocol (IMAP) and Internet Protocol Suite (TCP/IP).

An exemplary embodiment may also include keyboard, mouse, and other electronic inputs to the interactive printed material 10. Such additional inputs can be used to provide additional interaction with the outside protocol or application. For example, after the user touches the membrane of the interactive printed material 10 to command that an instant messaging 26 window be opened, the keyboard may be used to compose a message. Either touching the membrane or hitting the ENTER key on the keyboard would then send the message.

The membrane switch of the interactive printed material 10 may be any type of device capable of sensing and responding to pressure—for example, a push button, koala pad, or touch sensitivity pad. In an exemplary embodiment, the membrane switch of the interactive printed material 10 has a visual association with text and/or graphic content on the printed publication having printed content. It should be understood that while membrane switches are utilized in the present embodiment, it is within the scope of the invention that other actuators or switches could be used (such as, without limitation, magnetic actuators or pressure sensors).

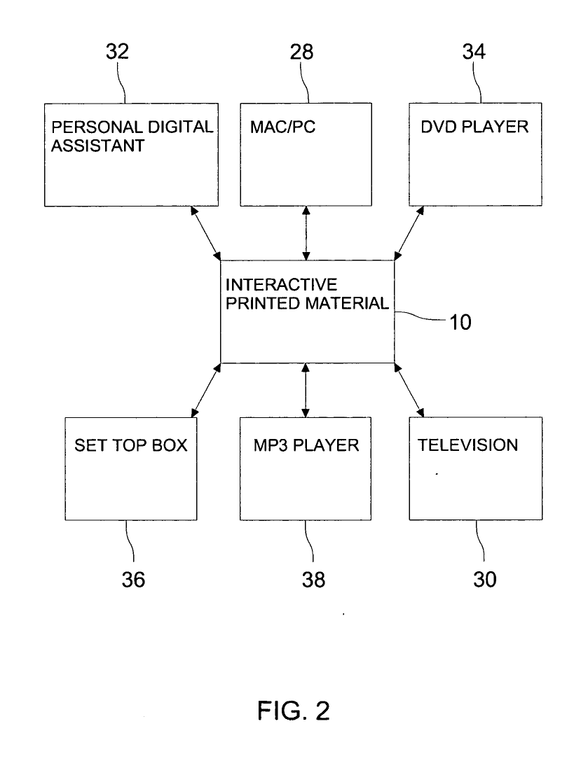

Referring to FIG. 2, when the user touches the text and/or graphics on the interactive printed material 10, pressure from the touch actuates the underlying membrane switch. The membrane switch(es) of the interactive printed material 10 is responsive to applied pressure (typically, the touch of the user's finger), and outputs a voltage specific to the location of the applied pressure. In an exemplary embodiment, the voltage from the interactive printed material 10 is indicative of the touched location and/or the touched item on the interactive printed material 10. This voltage is translated into a binary output and used to command a specific action by an output device. Output devices may include any electronic device such as a computer 28, television 30, personal digital assistant 32, digital video disc (DVD) player 34, set-top box 36, audio player 38, cell phone or any other device that is capable of responding to an electronic request by the interactive printed material 10.

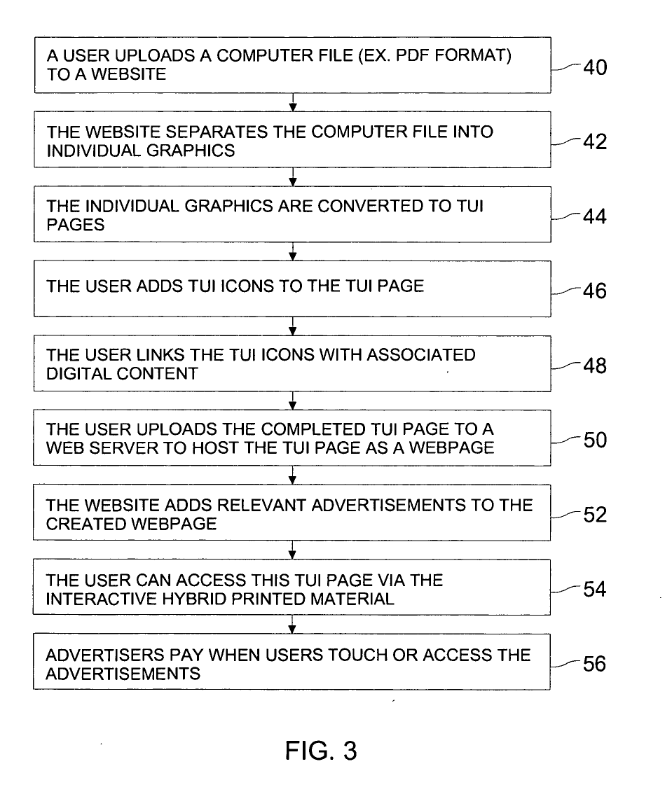

In FIG. 3, an exemplary embodiment of one aspect of the present invention is shown. Specifically, a method of creating or designing interactive hybrid pages, books, or content and creating revenue through advertising is shown. In one embodiment, the user may upload or transmit 40 a computer file such as a .PDF file to a website or web-service. The computer file may be separated 42 into individual graphic files by the interactive hybrid printed material 10 or the web-service. The individual graphic files are converted 44 into touch user interface (“TUI”) files. The user may then place 46 TUI icons (or images) from a web service palette into the TUI file. This may be accomplished by implementing a software application such as a browser. The user then builds a TUI page within the browser environment with a TUI icon palette and grid underlay or overlay. This palette may house TUI icons that the user can drag-and-drop from the palette onto their graphic pages. The user then links or associates 48 the TUI icons with digital content, applications, protocols, or interfaces. After a user finishes placing 46 TUI icons, the user may then upload or transmit 50 this TUI page to a hosted web server. The graphic file may be viewable in any browser. A hosting company may host the first TUI page for free. Every subsequent page may then require a paid subscription or be subsidized by advertising. The user may have this choice or the company may make this decision. If advertising is incorporated, advertisements such as GoogleAds® may be added 52 the TUI page. Any advertisements may be incorporated 52 into the TUI page. Additionally, company logos, slogans, or trademarks may be added to the hosted TUI page. An additional source of revenue may come from hosting the content to which the TUI icons are linked.

After completing the above process, the user may then access 54 and print the TUI page on a printer. This may then be placed in the interactive printed material 10 and used as an interactive TUI page. This page would appear similar to the webpage shown on the computer screen.

One embodiment can provide “touch-through” revenue. This touch-through revenue may be generated 56 each time a link, advertisement, or content is “touched” or activated by a user. This touch or activation may be accomplished by way of a user physically touching the printed page or by actuating on an output device, with a mouse or other input device. For example, if a user touches a printed advertisement for Company XYZ, the IPM hardware device initiates navigation to the Company XYZ website. Revenue may be generated 56 by tracking the traffic (such as the quantity of unique visitors) from an IPM hardware device and collecting a revenue stream corresponding to the traffic.

In another aspect of the present invention, an electronic portable document container called a rich media document (or a .rmd file) is provided. This container encloses not only an electronic document having digital content, but also includes an associated and integrated database. This database may be a routing table (similar to a table of contents) to the linked text and elements within the document. The linked and associated digital elements (links, content, email address, VOIP numbers, etc.) are maintained in the database, which is integrated with the document inside the container.

This document and database (collectively, a “rich media document”) provide three representations of the same content. The first representation is that the .rmd can be web-hosted digital content for a mouse-click experience. The second representation is that it can be screen-readable by a user, and the third representation is that it can be printed. The printed page, when incorporated with an IPM 10 hardware device, can be interacted with via a user's touch. A rich media document may include text-based elements and non-text based elements such as graphics, tables, pictures and/or other non-text based elements.

To generate an .rmd file, a source file may be submitted to a client-side application or web-service. The rendering process includes converting the source file to an .rmd file via a software application. This software application scans the document and allows a user to input metadata and links during the rendering process. Upon completion of the rendering process, the rich media document includes the converted document and associated metadata and links embedded in a database associated with the document.

It should be understood that the systems and methods described herein may be operating on a single computer server device, a networked group of computer servers, or any other networked computer device or computerized device or system of computer devices or computerized devices on which the tools and/or processes of the exemplary embodiments may operate.

The apparatuses, uses, and methods disclosed herein have been described without reference to specific hardware. However, the apparatuses, uses, and methods disclosed herein have been described in a manner sufficient to enable persons of ordinary skill in the art to readily adapt commercially available hardware as may be needed to reduce any of the embodiments of the present invention to practice without undue experimentation.

Following from the above description and invention summaries, it should be apparent to persons of ordinary skill in the art that, while the methods and apparatuses herein described constitute exemplary embodiments of the present invention, it is to be understood that the inventions contained herein are not limited to the above precise embodiments and that changes may be made without departing from the scope of the invention as defined by the claims. Likewise, it is to be understood that the invention is defined by the claims and it is not necessary to meet any or all of the identified advantages or objects of the invention disclosed herein in order to fall within the scope of the claims, since inherent and/or unforeseen advantages of the present invention may exist even though they may not have been explicitly discussed herein.

What is claimed is:

1. A method of outputting digital content from an interactive user device, comprising the steps of:
providing a printed publication including a plurality of printed objects associated with digital content, the printed objects having location coordinates relative to the printed publication;
providing an interactive user device having circuitry adapted to generate and transmit one or more location signal associated with the location coordinates;
providing a server device for storing the digital content;
providing an output device for outputting the digital content, the output device being electronically coupled to the interactive user device;
actuating, by a user, the circuitry corresponding to one of the plurality of printed objects;
upon actuation of the circuitry, transmitting a first signal from the interactive user device to the server device, the first signal including a request to access the digital content corresponding to the actuated printed object;
receiving a second signal from the server device, the second signal including at least one of the digital content, a location of the digital content, and instructions for outputting the digital content; and
outputting the digital content on the output device.

2. The method of claim 1, wherein the digital content is at least one of a protocol, an interface and an application.

3. The method of claim 2, wherein the application is at least one of a browser application, an email application, a messaging application, an voice-over-Internet-Protocol application, an image application, a video application and an audio application.

4. The method of claim 1, wherein the digital content is at least one of an Internet resource, a website, a networked resource, audio content, video content, and image content.

5. The method of claim 1, wherein the output device is at least one of a computing device, a personal computer, a personal digital assistant, a digital video disc (DVD) player, a television, a cellular device, an audio player device and a video player device.

6. A digital content transmission system, comprising:
a printed publication including a plurality of printed objects associated with digital content, the printed objects having location coordinates relative to the printed publication;
an interactive user device having circuitry adapted to generate and transmit one or more location signal associated with the location coordinates, the circuitry corresponding to one of the plurality of printed objects;
a server device for storing the digital content; and
an output device for outputting the digital content, the output device being electronically coupled to the interactive user device;
wherein the interactive user device is adapted to transmit a first signal, the first signal including a request to access the digital content corresponding to the actuated printed object; and
wherein the server device is adapted to transmit a second signal, the second signal including at least one of the digital content, a location of the digital content, and instructions for outputting the digital content.

7. The system of claim 6, wherein the digital content is at least one of a protocol, an interface and an application.

8. The system of claim 7, wherein the application is at least one of a browser application, an email application, a messaging application, an voice-over-Internet-Protocol application, an image application, a video application and an audio application.

9. The system of claim 6, wherein the digital content is at least one of an Internet resource, a website, a networked resource, audio content, video content, and image content.

10. The system of claim 6, wherein the output device is at least one of a computing device, a personal computer, a personal digital assistant, a digital video disc (DVD) player, a television, a cellular device, an audio player device and a video player device.

11. A method of initiating software instructions from an interactive user device, comprising the steps of:
providing a printed publication including a plurality of printed objects associated with digital content, the printed objects having location coordinates relative to the printed publication;
providing an interactive user device having circuitry adapted to generate and transmit one or more location signal associated with the location coordinates;
providing a server device for storing the digital content;
providing an output device electronically coupled to the interactive user device;
actuating, by a user, the circuitry corresponding to one of the plurality of printed objects;
upon actuation of the circuitry, executing software instructions configured to activate at least one of an application, a protocol, and an interface; and
outputting results of the executing step to the output device.

12. The method of claim 1, wherein the application is at least one of a browser application, an email application, a messaging application, an voice-over-Internet-Protocol application, an image application, a video application and an audio application.

13. The method of claim 1, wherein the protocol includes at least one of a communication protocol and a file transfer protocol.

14. The method of claim 13, wherein the protocol includes at least one of an Internet Protocol (IP), a Hypertext Transfer Protocol (HTTP), a File Transfer Protocol (FTP), a User Datagram Protocol (UDP), a Transmission Control Protocol (TCP), a Dynamic Host Configuration Protocol (DHCP), a Telnet Remote Protocol, a Secure Shell Remote Protocol (SSH), a Post Office Protocol 3 (POP3), a Simple Mail Transfer Protocol (SMTP), an Internet Message Access Protocol (IMAP) and an Internet Protocol Suite (TCP/IP).

15. A system for initiating software instructions for outputting digital content, comprising:
a printed publication including a plurality of printed objects associated with digital content, the printed objects having location coordinates relative to the printed publication;
an interactive user device having circuitry adapted to generate and transmit one or more location signal associated with the location coordinates, the circuitry corresponding to one of the plurality of printed objects;
a server device for storing the digital content; and
an output device electronically coupled to the interactive user device;
wherein actuation of the circuitry causes the interactive user device to execute software instructions configured to activate at least one of an application, a protocol, and an interface.

16. The system of claim 15, wherein the application is at least one of a browser application, an email application, a messaging application, an voice-over-Internet-Protocol application, an image application, a video application and an audio application.

17. The system of claim 15, wherein the protocol includes at least one of a communication protocol and a file transfer protocol.

18. The system of claim 17, wherein the protocol includes at least one of an Internet Protocol (IP), a Hypertext Transfer Protocol (HTTP), a File Transfer Protocol (FTP), a User Datagram Protocol (UDP), a Transmission Control Protocol (TCP), a Dynamic Host Configuration Protocol (DHCP), a Telnet Remote Protocol, a Secure Shell Remote Protocol (SSH), a Post Office Protocol 3 (POP3), a Simple Mail Transfer Protocol (SMTP), an Internet Message Access Protocol (IMAP) and an Internet Protocol Suite (TCP/IP).

19. A method of generating an interactive printed publication, comprising the steps of:
transmitting an electronic file to a server device, the electronic file representing a page having one or more graphical objects;
converting the plurality of graphical objects into a plurality of touch user interface pages;
adding an image to one or more of the touch user interface pages;
linking the image with digital content;
generating one or more interactive digital pages including the results from the linking step; and
printing onto a substrate the one or more interactive digital pages to create one or more interactive printed publications;
wherein the one or more interactive printed publications are visually substantially similar to the one or more interactive digital pages; and
wherein the actuation of one of the images on the one or more interactive printed publications causes the retrieval of the digital content.

20. The method of claim 19, further comprising the steps of:
transmitting the plurality of touch user interface pages to a hosting service; and
storing, by a hosting service, the plurality of touch user interface pages.

21. The method of claim 20, further comprising the steps of:
accessing, by a third party, one or more of the stored touch user interface pages;
recording, by the hosting service, information related to at least one of the third party, the user, the touch user interface pages and the accessing of the touch user interface pages;
generating revenue by the hosting service based, at least in part, on the accessing step.

22. The method of claim 19, further comprising the steps of:
generating one or more web pages related to the plurality of touch user interface pages;
adding electronic advertisements to the one or more web pages; and
allowing third parties to access to the one or more web pages.

23. The method of claim 19, wherein the image is at least one of an icon, an advertisement, a logo, a slogan, a trademark and a button.

24. The method of claim 19, wherein the steps are performed by a user via a website service.

25. The method of claim 19, wherein the user may print the touch user interface pages for use with an interactive user device.

26. A method of generating revenue through advertising, comprising the steps of:
providing a printed publication including a plurality of printed objects associated with digital content, the printed objects having one or more printed advertisements and having location coordinates relative to the printed publication;
providing an interactive user device having circuitry adapted to generate and transmit one or more location signal associated with the location coordinates;
providing a server device for storing the digital content;
providing an output device electronically coupled to the interactive user device;
actuating, by a user, the circuitry corresponding to the printed advertisement;
upon actuation of the circuitry corresponding to the printed advertisement, executing software instructions configured to retrieve a web page related to the printed advertisement; and
generating revenue from an entity related to at least one of the printed advertisement and the web page related to the printed advertisement based, at least in part, on the retrieval of the web page related to the printed advertisement.

27. The method of claim 26, further comprising the steps of:
completing an e-commerce transaction between the user and the web page; and
generating revenue from an entity related to at least one of the printed advertisement and the web page related to the printed advertisement based, at least in part, on the e-commerce transaction.
